(19) United States
(12) Patent Application Publication
(10) Pub. No.: US 2004/0144007 A1
(43) Pub. Date: Jul. 29, 2004

(54) Platform for the display of a document cover

(76) Inventor: Eugene G. Bilobram, Forked River, NJ (US)

Correspondence Address: Mr. Walter J. Tencza Jr., Suite 3, 10 Station Place, Metuchen, NJ, 08840, US

(21) Appl. No.: 10/351,116

(22) Filed: Jan. 24, 2003

(51) Int. Cl. G09F 3/18

(52) U.S. Cl. 40/661; 40/124; 40/737

(57) ABSTRACT

An apparatus and a method for displaying a document cover such as a certificate cover for an individual, objects relating to characteristics of the individual, and/or a picture holder with the individual's picture are disclosed. An apparatus comprising a wall, a slot, and a body portion is provided. A certificate cover can be inserted into the slot to hold the certificate cover in an upright position. One or more objects, representing one or more characteristics of an individual, can be inserted into a corresponding one of the one or more holes of the body portion. A picture holder, which may be centrally located with respect to the certificate cover, may also be provided.

### FIELD OF THE INVENTION

This invention relates to improved methods and apparatus concerning the display of certificates such as diplomas, or awards.

### BACKGROUND OF THE INVENTION

Many times documents, such as diplomas or awards, are presented in a certificate cover. These covers may also be referred to as a diploma cover, a document cover, or an award cover.

The certificate is typically mounted to the inside of a back cover of the certificate cover. The certificate cover typically also includes a front cover, the inside of which may have a textile lining. The inside of the front cover may also include a drawing such as a picture of a school building or a school mascot. The outside of the certificate cover is sometimes a leatherette material available in various colors. The color of the outer surface of the certificate cover may represent the school's colors.

There are insufficient known methods and apparatus to display a certificate cover. As a result, the certificate cover may end up stuffed into a drawer or in a box in the attic for example. In some cases the diploma or certificate is removed from the cover and mounted in a picture frame or wall plaque.

### SUMMARY OF THE INVENTION

The present invention in one or more embodiments provides a platform to display a document in a document cover, such as a certificate in a certificate cover, without removing the document from the document cover. The invention may be further comprised of one or more items, objects, or figurines of personalization. A picture holder and/or one or more figurines and possibly an imprinted nameplate may be included.

The present invention in one or more embodiments provides an apparatus and a method for displaying a certificate cover for an individual or for a group or a theme, objects or figurines relating to characteristics of the individual or the group or the theme, and/or a picture holder with the individual's picture or a group's picture of a picture consistent with a theme.

The present invention in one or more embodiments provides an apparatus comprised of a platform, which at least in one embodiment is comprised of a wall, a slot, and a body portion. The wall may be comprised of a first portion and a second portion. The first portion of the wall may be at an angle of less than one hundred and eighty degrees with respect to the second portion of the wall. The slot may be comprised of a first portion and a second portion. The first portion of the slot may be at an angle of less than one hundred and eighty degrees with respect to the second portion of the slot. The body portion may be shaped substantially in the form of a triangle. The body portion may have one or more holes. The body portion may have a front surface, which has attached to it a plate, nameplate, or plaque. The plate or nameplate, or plaque may have one or more alphanumeric characters printed or engraved on it, which may state something about an individual or a group or a theme.

The apparatus may also be comprised of a document cover such as a certificate cover. The certificate cover can be inserted into the slot to hold and secure the certificate cover in an upright position. The certificate cover may be comprised of a front cover and a back cover. The front cover can be inserted into the first portion of the slot and the back cover can be inserted into the second portion of the slot. The certificate cover may have a thickness, which is slightly less than a width of the slot. One or more objects, which can be inserted into a corresponding one of the one or more holes of the body portion. The one or more objects may represent one or more corresponding characteristics of an individual. The apparatus may be further comprised of a picture holder.

The present invention in one or more embodiments may also include a method comprising the steps of placing a document cover, such as a certificate cover in an upright position. The certificate cover may be placed in the upright position by placing a front cover of the certificate at an angle of less than one hundred eighty degrees with respect to a back cover of the certificate. The certificate cover may be placed in the upright position so that an inside of the front cover and an inside of the back cover can be seen simultaneously. The method may be further comprised of placing a one or more objects adjacent to the certificate cover, so that the one or more objects can be seen simultaneously along with the inside of the front cover and the inside of the back cover. The method may include placing a nameplate adjacent the certificate cover, and placing a plate, nameplate, or plaque adjacent the certificate cover. The body portion itself may have engraving on it such as by laser engraving.

Certificates, as the term is used in this application, may include diplomas, award certificates, certificates of marriage, certificates of birth, award appreciation or virtually any document that one may find worthy of display. Another use of this invention may be the display of other types of documents, such as photos in a document cover, such as the display of a team photo in a document cover. The photo of the team may be found where the diploma or certificate is located in the first example. The team picture would therefore provide the back drop and a close up photo of the individual player could be included in an adjacent photo frame. There may be a figurine(s) of a soccer ball or player and indicia on the front surface of the body indicating players name, team record, and team names etc.

### BRIEF DESCRIPTION OF THE DRAWINGS

FIG. 1 shows a top view of a first apparatus in accordance with an embodiment of the present invention;

FIG. 2 shows a bottom view of the first apparatus of FIG. 1;

FIG. 3 shows a front view of the first apparatus of FIG. 1;

FIG. 4 shows a side view of the first apparatus of FIG. 1;

FIG. 5 shows a perspective view of the first apparatus of FIG. 1;

FIG. 6 shows a perspective view of the first apparatus of FIG. 1 along with a dashed line perspective view of an certificate cover; and

FIG. 7 shows a perspective view of a second apparatus in accordance with an embodiment of the present invention, which includes the first apparatus of FIG. 1, the certificate cover of FIG. 6, first and second objects, and a picture holder.

### DETAILED DESCRIPTION OF THE DRAWINGS

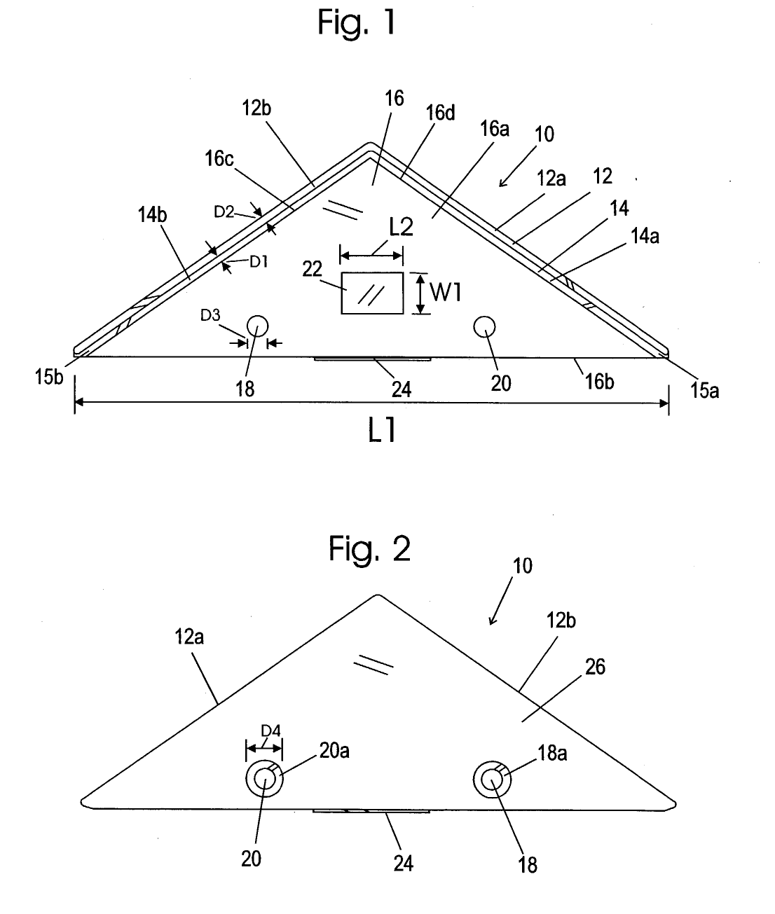

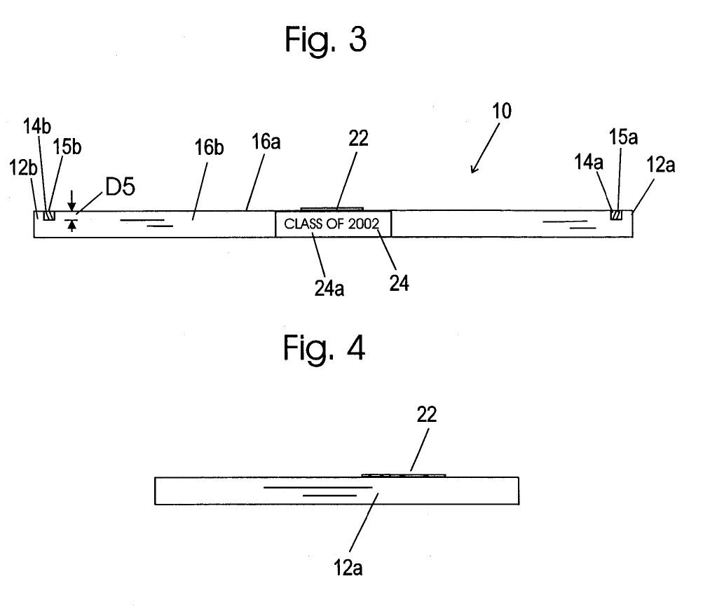

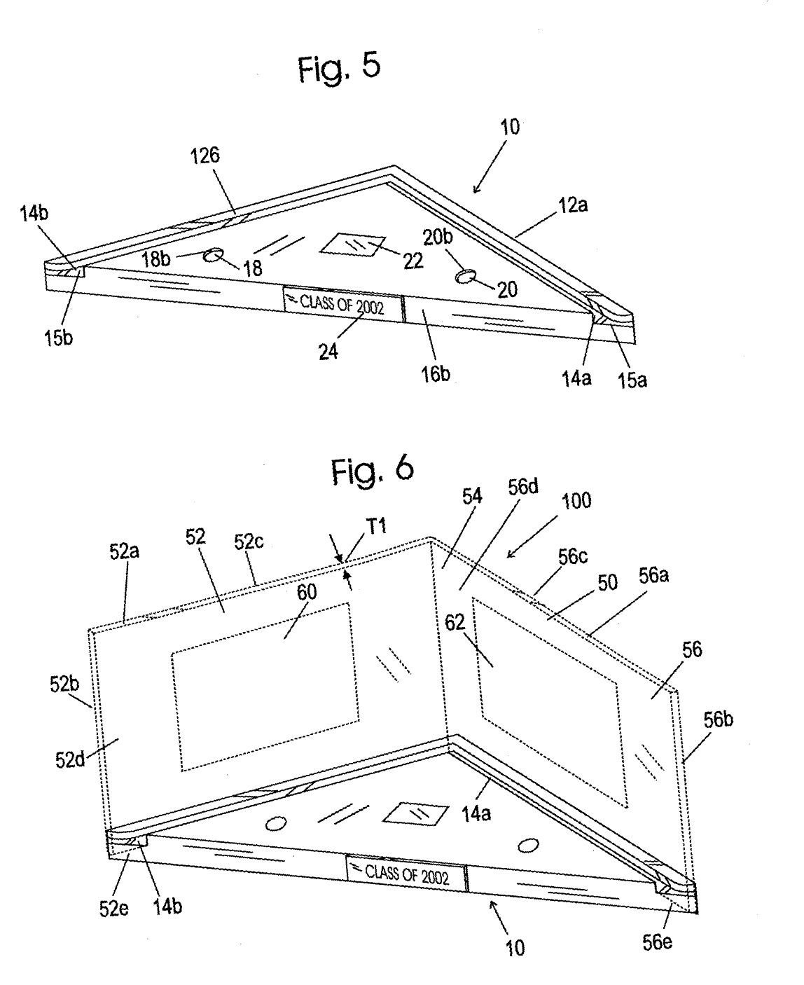

FIG. 1 shows a top view of a first apparatus 10 in accordance with an embodiment of the present invention. FIG. 2 shows a bottom view of the first apparatus 10. FIG. 3 shows a front view of the first apparatus 10. FIG. 4 shows a side view of the first apparatus 10. FIG. 5 shows a perspective view of the first apparatus 10.

The first apparatus 10 includes a rail or wall 12, which includes portions 12a and 12b. The first apparatus 10 further includes a slot or indentation 14, which includes portions 14a and 14b. The portion 14a has a end 15a and the portion 14b has an end 15b. The slot 14 may have a depth of D5, as shown in FIG. 3, which may be about one-quarter of an inch. The first apparatus 10 further includes a substantially triangular body portion 16. The body portion 16 is solid with the exception of holes 18 and 20 and the indentations 18a and 20a. The indentations 18a and 20a are shown in FIG. 2. The holes 18 and 20 have inner surfaces 18b and 20b as shown in FIG. 5.

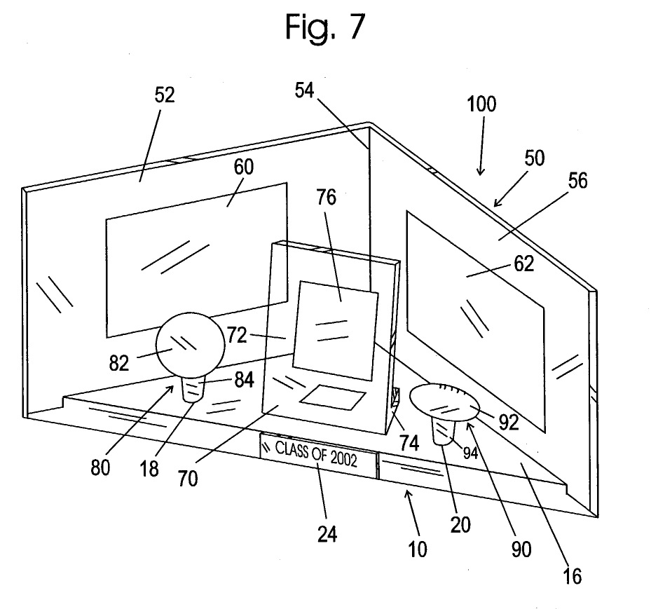

The first apparatus 10 also includes a nameplate 24, which can be glued or fixed in some other manner to a front surface 16b of the body portion 16. The nameplate 24 may have indicia, such as indicia 24a, printed or engraved on it, such as indicia indicating a graduation class. In FIG. 3, the indicia 24A is shown as “CLASS OF 2002”. The first apparatus 10 also includes an attachment device 22 which may be connected in any manner to a top surface 16a of the body portion 16. The attachment device 22 may be a strip of adhesive material or a slot or clips to which a picture holder, such as picture holder 70 in FIG. 7, can be attached.

The apparatus 10 may have a length L1, which may be about fifteen inches. The slot or indentation portions 14a and 14b may each have a width of D1, which may be about one-quarter of an inch. The wall or rail portions 12a and 12b may each have a width of D2, which may be about one-quarter of an inch. The attachment device 22 may have a width W1 that may be about one inch and a length, L2, which may be about one and one half inches. The holes 18 and 20, may each have a diameter, D3, of about one-quarter of an inch and the indentations 18a and 20a may have a diameter, D4 of about three quarters of an inch.

FIG. 6 shows a perspective view of the first apparatus 10 of FIG. 1 along with a dashed line perspective view of a certificate cover 50. FIG. 7 shows a perspective view of a second apparatus 100 in accordance with an embodiment of the present invention, which includes the first apparatus 10, the certificate cover 50, first and second objects 80 and 90, and a picture holder 70.

The certificate cover 50 includes a front cover 52, a binding 54, and a back cover 56. The front cover 52 includes a portion 60 which may include a picture or drawing of a school from which an individual has graduated. The front cover 52 has a top edge 52a, a side edge 52b, an outside or outside surface 52c, an inside or inside surface 52d, and a bottom edge 52e. The back cover 56 includes a portion 62 which may include a diploma or a copy or representation of a diploma from the school from which the individual has graduated. The back cover 56 includes a top edge 56a, a side edge 56b, an outside or outside surface 56c, an inside or inside surface 56d, and a bottom edge 56e. The first object 80 may be comprised of a golf ball or representation of a golf ball 82 connected to an attachment device 84. The attachment device 84 can be inserted into the hole 18 to attach the first object 80 to the body portion 16 of the apparatus 10. The attachment device 84 may be threaded and may be screwed into a nut (not shown which usually would be larger than the hole 18), which can be inserted into the recess 18a. The second object 90 may be comprised of a representation of a football 92 connected to an attachment device 94. The attachment device 94 can be inserted into the hole 20 to attach the second object 90 to the body portion 16 of the apparatus 10. The attachment device 94 may be threaded and may be screwed into a nut (not shown which would at least in one embodiment be larger than the hole 20), which can be inserted into the recess 20a.

When the certificate cover 50 is placed in the apparatus 10 as shown by FIGS. 6 and 7, the side edge 52b of the front cover 52 is substantially near the end 15b of the slot portion 14b while at the same time the side edge 56b of the back cover 56 is substantially near the end 15a of the slot portion 14a. This gives the combination of the certificate cover 50 and the apparatus or base or platform 10, a smooth appearance near the ends 15b and 15a and provides for stability of certificate cover 50 situated in the slot portions 14a and 14b. To this end, the length of the slot portions 14a and 14b may be about the length of bottom edge 52e of the front cover 52 and the bottom edge 56e of the back cover 56.

The first and second objects or figurines 80 and 90 can be, or can be replaced by any type of objects or figurines, which represent an interest, sport, hobby, extracurricular activity, or personality trait of an individual or of a group of individuals. For example, the first or the second object could be a representation of a runner if an individual is a track athlete, a bird if an individual is a bird watcher, a horse if an individual rides horses, a clown if an individual was class clown, or any other objects to represent any other interests or characteristics of an individual. The term “characteristics” of an individual or group is defined in this application to include any accomplishments of an individual or group, interests of an individual or group, or traits of an individual or group. The first and second objects 80 and 90 may be replaced by a depiction of the school mascot and the United States flag, for example,

The picture holder 70 may have a portion 72 which may hold a picture 76 of the individual who has graduated. The portion 72 may be inclined and fixed with respect to a base 74. The picture holder 70 may be made of transparent hard plastic. The picture holder 70 can be attached to attachment device 22 to substantially centrally locate and attach the picture holder 70 on and to the body portion 16 of the apparatus 10. The picture holder 70 may be attached adjacent to the certificate cover 50 and substantially centrally with respect to the certificate cover 50.

In operation, the apparatus 10 will, at least in one embodiment, be placed in the position or state shown in FIG. 5. The front cover 52 and the back cover 56 are placed in the slot portions 14b and 14a, respectively, as shown by FIGS. 1, 5, 6, and 7. The binding 54 of the certificate cover 50 is placed in the slot 14 at a location where slot portions 14b and 14a meet. The slot 14 width D1, shown in FIG. 1, can be slightly greater than the thickness T1, shown in FIG. 6, so that the certificate cover 50 is held tightly in place. The front cover 52 is held in place by the wall portion 12b and a surface 16c of the body portion 16. The back cover 56 is held in place by the wall portion 12a and a surface 16d of the body portion 16. After or before, the cover 50 is inserted into the slot 14, the objects 80 and 90 can be inserted into the holes 18 and 20 respectively (and fixed by nuts placed in recesses 18a and 20a), and the base 74 of the picture holder 70 can be placed on top of and attached to the attachment device 22 as shown in FIG. 7. The assembled apparatus 100 of FIG. 7 allows someone to simultaneously see the majority of the picture 76 of the individual who has graduated, the portion 62 (at least in one embodiment a diploma or other certificate), the portion 60 (at least in one embodiment, an artist rendering of the school graduated from, but could be blank), and the objects 80 and 90. The apparatus 100 presents a pleasing visual display of the individual's accomplishments and interests.

The slot portion 14a can be at an angle of less than one hundred eighty degrees with respect to the slot portion 14b. This configuration allows the certificate cover 50 to stand upright, to be open, and allows portions 60 and 62 to be easily seen simultaneously. In other embodiments, the slot 14 could be replaced by clips or the certificate cover 50 could simply be stood up in the open configuration of FIG. 7, with front cover 52 at an angle of less than one hundred eighty degrees with respect to back cover 56, without the use of a slot 14.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus which serves as a platform for a document cover comprising:
a wall comprised of a first portion and a second portion, the first portion of the wall at an angle of less than one hundred and eighty degrees with respect to the second portion of the wall;
a slot comprised of a first portion and a second portion, the first portion of the slot at an angle of less than one hundred and eighty degrees with respect to the second portion of the slot; and
a body portion.

2. The apparatus of claim 1 wherein
the document cover is a certificate cover.

3. The apparatus of claim 1 wherein
the body portion has one or more holes.

4. The apparatus of claim 1 wherein
The slot has a width of about one quarter of an inch.

5. The apparatus of claim 1 wherein
The wall has a width of about one quarter of an inch.

6. The apparatus of claim 1 wherein
The body portion has a first dimension of about fifteen inches.

7. The apparatus of claim 1 wherein
The body portion has a front surface, which has attached to it a nameplate.

8. The apparatus of claim 7 wherein
the nameplate has one or more alphanumeric characters on it.

9. The apparatus of claim 1 further comprising
a document cover; and
wherein the document cover can be inserted into the slot to hold the document cover in an upright position.

10. The apparatus of claim 9 wherein
the document cover is comprised of a front cover and a back cover; and
wherein the front cover can be inserted into the first portion of the slot and the back cover can be inserted into the second portion of the slot.

11. The apparatus of claim 9 wherein
the document cover has a thickness, which is slightly less than a width of the slot.

12. The apparatus of claim 10 wherein
the front cover has a thickness, which is slightly less than a width of the first portion of the slot, and the back cover has a thickness, which is slightly less than a width of the second portion of the slot.

13. The apparatus of claim 3 further comprising
one or more objects, which can be inserted into a corresponding one of the one or more holes of the body portion.

14. The apparatus of claim 13 wherein
the one or more objects represent one or more corresponding characteristics of an individual.

15. The apparatus of claim 13 wherein
the one or more objects represent one or more corresponding characteristics of a group.

16. The apparatus of claim 1 further comprising
a picture holder.

17. The apparatus of claim 1 wherein
the body portion has a substantially triangular shape.

18. A method comprising the steps of:
placing a document cover in an upright position;
wherein the document cover is comprised of a front cover and a back cover, which are connected by a binding;
wherein the document cover is placed in the upright position by placing the front cover at an angle of less than one hundred eighty degrees with respect to the back cover; and
wherein the document cover is placed in the upright position so that the an inside of the front cover and an inside of the back cover can be seen simultaneously.

19. The method of claim 18 further comprising
placing a one or more objects adjacent to the document cover, so that the one or more objects can be seen simultaneously along with the inside of the front cover and the inside of the back cover.

20. The method of claim 19 wherein
the document cover includes a certificate belonging to an individual; and
the one or more objects represent one or more characteristics of the individual.

21. The method of claim 18 further comprising
placing a picture holder adjacent the document cover.

22. The method of claim 18 further comprising
placing a nameplate adjacent the document cover.

23. The method of claim 21 wherein
the document cover includes a certificate belonging to an individual; and
and the nameplate has indicia which states something about the individual.

24. The method of claim 18 further comprising
securing the document cover in the upright position.
